(19) United States
(12) Patent Application Publication
(10) Pub. No.: US 2010/0313037 A1
(43) Pub. Date: Dec. 9, 2010

(54) COLLECTIBLE CASE AUTHENTICATION SYSTEM, DEVICE AND METHOD

(76) Inventor: Rory A. Ward, Gunnison, UT (US)

Correspondence Address: Jason P. Webb, 8841 S Redwood Rd, Suite C, West Jordan, UT, 84088, US

(21) Appl. No.: 12/786,050

(22) Filed: May 24, 2010

Related U.S. Application Data
(60) Provisional application No. 61/184,150, filed on Jun. 4, 2009.

(51) Int. Cl. G06F 12/14; G06Q 30/00

(52) U.S. Cl. 713/189; 705/50

(57) ABSTRACT

There is a collectible case authentication device and method configured to facilitate authentication of a collectible. The collectible case authentication device includes a secured housing and a data interface module. The collectible case authentication device also includes a data storage device including an authentication module. The authentication module includes an encryption module including a public key associated with a private key. The authentication module also includes a communication module configured to communicate over a computerized network with a computerized registry to authenticate the collectible. The authentication module further includes a digital signature derived from the private key. Furthermore, the authentication module includes a user interface module configured to provide a user interface. The collectible case authentication device also includes a global positioning module in communication with the data storage device and a secured receptacle securely coupled to the data storage device and configured to store a collectible.

### CROSS-REFERENCE TO RELATED APPLICATIONS

This invention claims priority, under 35 U.S.C. §120, to the U.S. Provisional Patent Application No. 61/184,150 to Rory A. Ward filed on Jun. 4, 2009, which is incorporated by reference herein.

### BACKGROUND OF THE INVENTION

1. Field of the Invention

The present invention relates to collectibles, specifically to collectible authentication systems, devices and methods.

2. Description of the Related Art

Authentication is the act of establishing or confirming something (or someone) as authentic, that is that claims made by or about the subject are true. This might involve confirming the identity of a person, the origins of an artifact, or assuring that a computer program is a trusted one. Authentication of collectibles has long been a reputable profession; however, collectible forgery, fraud, and counterfeiting including false documentation and false authentication of the collectible are continuing problems. It is often difficult to determine the authenticity of a collectible. Some improvements have been made in the field. Examples of references related to the present invention are described below, in their own words, and the supporting teachings of each reference are incorporated by reference herein:

U.S. Pat. No. 7,360,081, issued to Pretorius, discloses a method of authenticating an article includes the steps of, at an issuing station, selecting an inherent feature of the article and converting the feature into digital data to form an identification code for the article. An encryptor is used to encrypt the identification code utilizing a secret private key of an asymmetric encryption key pair and associated with the issuing party. The encrypted code is made available on a label accompanying the article. During a subsequent phase and at an authentication station, digital data relating to the feature is determined directly from the article and the code is decrypted utilizing a public key of the pair obtained from a third party in accordance with rules of a public key infrastructure. The determined data and the data relating to the feature retrieved from the decrypted code are compared to authenticate the article.

U.S. Pat. No. 5,673,338, issued to Denenberg et al., discloses a method and system for determining the authenticity of an item such as an original work of art, an art print, valuable jewelry or other valuable items utilizes images of one or more unique patterns of features, preferably at a microscopic level, as one or more “signatures” of the item. The image of this unique signature is recorded and stored electronically as data representing the unique pattern. The data are registered with identifying text and stored in a secure storage location, to prevent unauthorized duplication or use of the stored data. Following this registration and storage, an item presented as authentic can be examined microscopically at prescribed sites on the item where the original images were taken. Comparison is made at one or more of the sites, and a decision is made as to whether the item exhibits substantially identical features to those originally registered, so as to be the same authentic item. Comparison can be made electronically or visually/microscopically. The storage location can be a central location remote from local verification stations, with data transferred to and from local stations by telephone lines or other communication links.

U.S. Patent No. 5,778,071, issued to Caputo et al., discloses a portable security device is disclosed which can be carried by an individual and connected directly to telephone circuits to both authenticate that individual and encrypt data communications. The invention can operate as an electronic “token” to uniquely identify the user to a network, to a computer system or to an application program. The “token” contains the complete network interface, such as a modem, which modulates the data and provides the circuitry required for direct connection to the network. Furthermore, this “token” will preferably not permit communications to proceed until the device, and optionally the user, has been identified by the proper authentication. The token also contains all of the cryptographic processing required to protect the data using data encryption or message authentication or digital signatures or any combination thereof. Thus, the present invention provides the user with all of the communications and security equipment needed for use with personal computers and electronic notebooks and eliminates the need for any other security measures and/or devices.

U.S. Patent Application Publication No. 2001/0049606, by Lucarelli, discloses an Internet-based system for registering and assuring authentication of a unique, collectible item is provided which includes an individual web page hosted by an online company for that unique item, wherein the web page displays a digital image, written description and current owner of that unique item. The individual web page is assigned a unique URL address and password. This web page represents an electronic title of ownership viewable by any Internet connection worldwide in a format that excludes the owner's personal information. As the object is sold, traded or otherwise changes owners, this process is facilitated by the additional exchange of the Internet-based electronic title, as the current owner transfers the password to the new owner who subsequently changes the personal ownership information on the electronic title.

U.S. Patent Application Publication No. 2008/0082813, by Chow, discloses techniques for booting a host computer from a portable storage device with customized settings with secure measure are described herein. According to one embodiment, in response to detecting a portable storage device inserted into a first host computer, the portable storage device is authenticated using a private key stored within the portable storage device against a public key stored in a second host computer over a network. In response to a successful authentication, data representing a personal working environment associated with a user of the portable storage device is downloaded from the second host computer over the network. After reboot, the first host computer is configured using the obtained settings of the personal working environment, such that the user of the portable storage device can operate the second host computer in view of the personal working environment. Other methods and apparatuses are also described.

The inventions heretofore known suffer from a number of disadvantages which include being ineffective; being expensive, being easily reproduced, faked and/or copied; being limited in application; being unreliable; being unduly complex; and/or being limited in use.

What is needed is a collectible case authentication device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available authentication. Accordingly, the present invention has been developed to provide an effective authentication system, device and/or method.

According to one embodiment of the invention there is a collectible case authentication system configured to authenticate a collectible against a computerized registry. The system may include a computerized registry that may be in communication with a network. The computerized registry may include a control module that may be configured to manage authentication of a collectible case. The computerized registry may also include a data storage module that may be in communication with the control module and/or that may be configured to store data. The computerized registry may include a network communication module that may be in communication with the control module and/or that may be configured to communicate across a network.

In addition, the computerized registry may include a confirmation module that may be in communication with the control module and/or may include a private key. The confirmation module may include a second private key that may have no associated public key on a data storage device. The computerized registry may include a tracking module that may be in communication with the control module and/or may be configured to track authentication history. The tracking module may track one or more, or each authentication event by an authentication characteristic. The data storage device may track each authentication, perhaps by a matching characteristic. Furthermore, the computerized registry may include an advertising module that may be configured to push advertising media to be displayed on the user interface module.

The collectible case authentication system may include a collectible case authentication device that may be configured to facilitate authentication of a collectible. The collectible case authentication device may include a secured housing. The collectible case authentication device may also include a data interface module that may be coupled to the secured housing and/or may be configured to communicate with a computerized device. In addition, the collectible case authentication device may include a data storage device that may be in communication with the data interface module, coupled to the secured housing and/or configured to store data. There may be an authentication module.

An authentication module may include an encryption module that may include a public key that may be associated with a private key. The authentication module may also include a communication module that may be in communication with an encryption module and/or a data interface module and/or that may be configured to communicate over a computerized network. The authentication module may include a digital signature derived from the private key and may be in communication with the communication module. Furthermore, the authentication module may include a user interface module that may be in communication with the communication module and/or that may be configured to provide a user interface. The user interface module may display an advertisement during authentication.

Moreover, the authentication history may include an authentication characteristic that may be selected from the group of authentication characteristics consisting of authentication number, ip address of a previous authentication, authentication time, authentication location, second digital signature, historical gps data, and owner information.

The collectible case authentication device may include a global positioning module that may be in communication with the data storage device and/or that may be configured to locate a global position of the secured housing. The housing may include an optical marker. The device may include a secured receptacle that may be securely coupled to the data storage device and/or that may be configured to store a collectible.

According to one embodiment of the invention, there is a method of authenticating a collectible. The steps of authenticating a collectible may include providing a secured housing that may include a data interface module that may be configured to provide interface controls to the housing. The secured housing may include a data storage device that may be in communication with the data interface module that may be configured to store data and/or may include an authentication module. The authentication module may include a communication module that may be in communication with the data interface module and/or that may be configured to communicate. The authentication module may include a digital signature that may be derived from a private key and/or that may be in communication with the communication module. The authentication module may include a user interface module that may be in communication with the communication module and/or that may be configured to provide an user interface.

The secured housing may include a global positioning module that may be in communication with the data storage device and/or that may be configured to locate a global position of the secured housing. The secured housing may also include a secured receptacle that may be securely coupled to the data storage device and/or that may be configured to store a collectible. The method may include securing the collectible within the secured receptacle. The method may include receiving an authentication request from the authentication module over a computerized network. The method may include a step of comparing the authentication request against a computerized registry including a record associated with the secured housing.

The method may include the step of tracking authentication events according to an authentication characteristic. The method may include the step of receiving a second authentication request including information associated with the tracked authentication characteristic and/or comparing the second authentication request against the tracked authentication characteristic. The method may include the step of pushing a media presentation to the interface module. The method may include a step of, if authentication fails, pushing a second digital signature to the data storage device, wherein the second digital signature is associated with an authentication failure record. Moreover, the method may include the step of tracking authentication history that may be according to an authentication characteristic including a characteristic selected from the group of authentication characteristics consisting of authentication number, IP address of a previous authentication, authentication time, authentication location, second digital signature, historical GPS data, and owner information.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of an authentication system, according to one embodiment of the invention;

FIG. 2 is a network diagram of a collectible case authentication system, according to one embodiment of the invention;

FIG. 3 is a module diagram of a collectible case authentication device, according to one embodiment of the invention;

FIG. 4 is a module diagram of a computerized registry, according to one embodiment of the invention;

FIG. 5 is an exploded perspective view of a collectible case authentication device, according to one embodiment of the invention; and

FIG. 6 is a flowchart of a collectible case authentication method, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows 7, Microsoft operating systems, Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

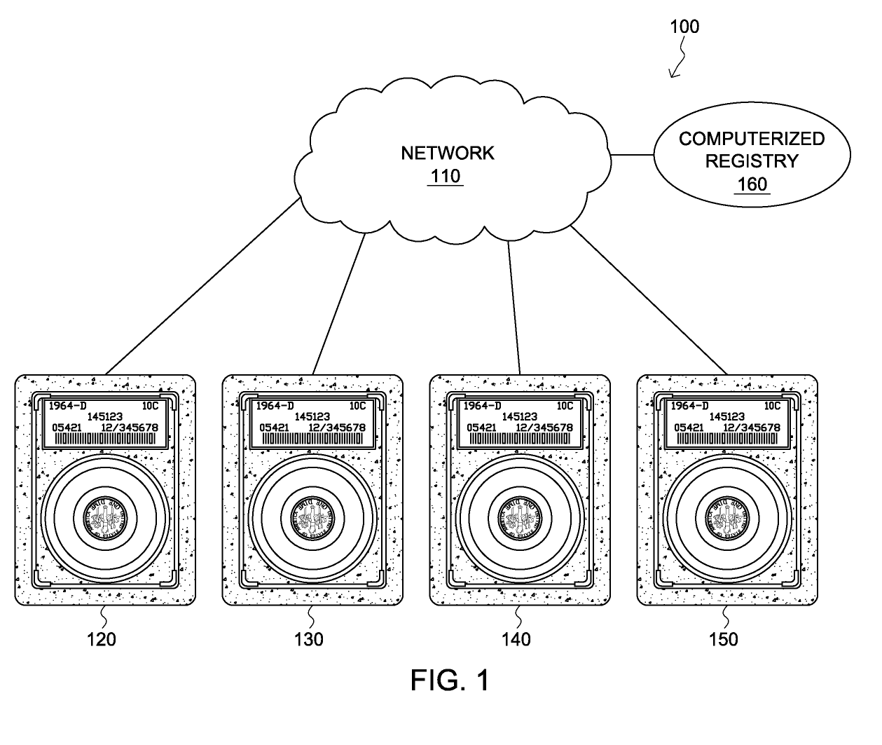

FIG. 1 is a network diagram of an authentication system 100. The illustrated authentication system 100 facilitates the authentication of a collectible through a network 110 by retrieving data from a collectible authentication case 120, 130, 140, and/or 150 and comparing data with a computerized registry 160 over the computerized network 110. Generally, a physical and professional authentication has taken place, wherein the collectible is examined and inspected according to criteria designed to determine authenticity of the physical collectible. The collectible is then placed in the case and thereby associated with a certification number or the like that may be verified against a list kept by the professional. Accordingly, a holder of the case may contact the professional, such as by phone or over a computerized network, and may request information about a particular certification number. Information may be returned and thereby confidence in the authenticity of the collectible may be established. Data used thusly may be serial numbers, authentication numbers, coded numbers, etc. disposed on the collectible authentication cases 120, 130, 140, 150. However, one notes that the illustrated cases 120-150 each carry identical information, yet separate physical objects. Counterfeiters are able to manufacture fake collectible authentication cases along with reproduced data and documentation associated with an authentic collectible. Accordingly, as illustrated, a plurality of reproduced Documentation may be certification documents, confirmation documents, authentication documents, registered documents, notarized documents, etc. Counterfeiters may then sell these duplicates over distribution networks where purchasers are not aware of each other, such as but not limited to internet auction websites. Accordingly, a professional authenticator may, appropriately, receive a plurality of authentication requests from prospective purchasers and purchasers and verify the information associated with the certification data on the case each time. Thereby, a false sense of confidence in the authenticity of duplicate sold items is developed, to the financial benefit of the counterfeiter and the degradation of the market for collectibles.

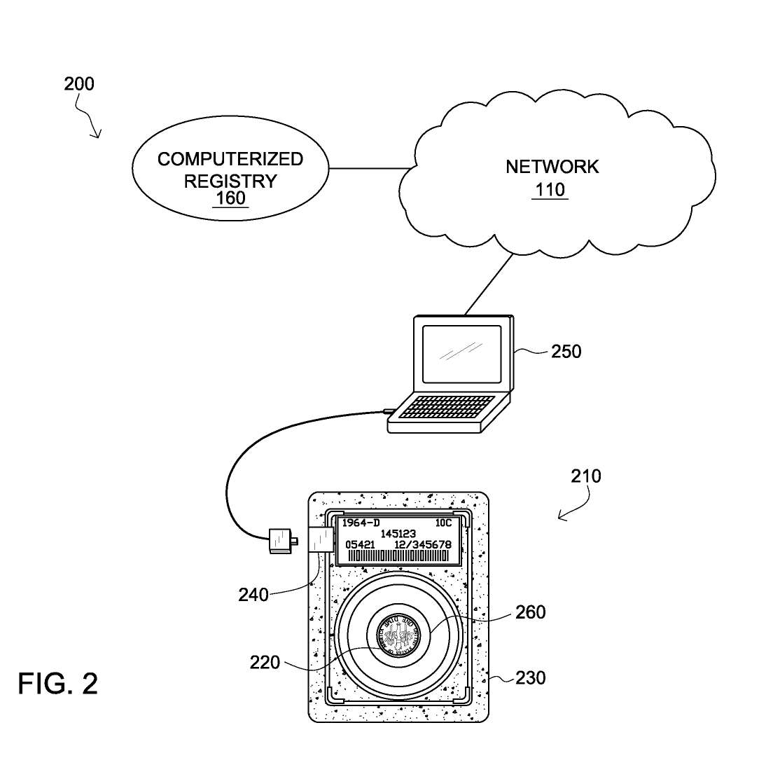

FIG. 2 is a network diagram of a collectible case authentication system 200, according to one embodiment of the invention. The illustrated collectible case authentication system 200 includes a collectible case authentication device 210 configured to facilitate authentication of a collectible 220 selectably coupleable to a computerized device 250 in communication with a network 110 in communication with a computerized registry 160. Accordingly, the collectible case authentication device 210 may be in communication with a computerized registry 160.

The illustrated collectible case authentication device 210 includes a secured housing 230, a data interface module 240, and a collectible 220 disposed within a secured receptacle 260. Accordingly, the illustrated collectible 220 is protected within the secured housing 230 (from damage, exposure, loss, disassociation, and/or etc.) and associated with the data interface module 240.

The illustrated secured housing 230 is a card shaped plastic casing configured to keep the collectible 220 disposed therein. The secured housing 230 may include one or more protective and/or anti-tamper features such as but not limited to one-way close mechanisms, seals, tamper evident seals, environmental seals (liquid proof, gas proof, heat transfer resistant, etc.), and the like and to a degree appropriate to the value of the collectible to be secured. A housing may be shaped and sized to be appropriate for the contents thereof.

A housing may also include an optical marker that provides a visual cue as to the authenticity and/or continued integrity of the secured housing and/or its contents. In one embodiment, an optical marker includes a chemical/material configured to provide a notable visual effect, such as but not limited to fluorescence, UV fluorescence, iridescence, holography, and the like. The optical marker may also be configured to alter its notable visual effect upon exposure to air, such as but not limited to if there is a breach in the seal of the secured housing. A non-limiting examples of an optical marker may be an optical marker described in U.S. Pat. No. 5,879,234, issued to Mengual, which is incorporated for their supported teachings herein. Non-limiting examples of a chemical marker may be chemical markers described in U.S. Pat. No. 6,641,052, issued to

Bailood et al., and in U.S. Pat. No. 5,411,034, issued to Beck, which is incorporated for their supported teachings herein.

The illustrated data interface module 240 permits selectable machine readable interface for an exterior computing device to information disposed on and/or within the secured housing 230. As a nonlimiting example, the data interface module may include a universal serial bus device, a serial cable, a parallel cable, a micro-USB device, a network cable, a wireless transponder, and/or any other data transfer device.

The illustrated collectible 220 disposed within a secured receptacle 260 is a dime (coin) held within a void formed by the interior shape of the secured housing 230. Collectibles come in a great variety of sizes, shapes, types, and other characteristics. Nonlimiting examples include: coins, stamps, cards, dolls, objects of art, toys, and the like. Secured receptacles are generally formed to receive and/or protect the collectibles and vary as well. Nonlimiting examples include: blister packs, hermetically sealed containers, transparent containers, heat resistant containers, UV resistant containers and the like.

The collectible case authentication device 210 also includes a data interface module 240 coupled to the secured housing 230 and configured to communicate with a computerized device 250. The computerized device may be a computer, a processor, a smartphone or any computing device. The illustrated computerized device is in communication with a computerized network. The collectible case authentication device 210 is configured to couple to the computerized device and then to send data to a computerized registry 160 over a computerized network 110 to authenticate the collectible 220 and may do so according to one or more communication protocols including but not limited to TCP/IP, HTTP, FTP, and the like and/or combinations thereof. The computerized registry 160 is configured to authenticate data from the collectible case authentication device 210. Authentication may be accomplished by one or more encryption/validation/authorization systems, such as but not limited to exchange and/or transfer of authentication information to and/or from the collectible case authentication device to and/or from a computerized registry by use of public/private key pairs.

The following encryption/validation/authorization systems are incorporated herein by reference for their supporting teachings: U.S. Pat. No. 5,563,950; U.S. Pat. No. 5,778,072; U.S. Pat. No. 6,317,829; U.S. Pat. No. 6,084,969; U.S. Pat. No. 5,491,752; and U.S. Pat. No. 5,778,072.

In operation of one embodiment of the invention, a user purchases a collectible disposed in a collectible case authentication device. The user couples the data interface module of the collectible case authentication device to a computerized device. The data interface module of the collectible case authentication device sends encrypted data to the computerized registry over a computerized network through the computerized device. The encrypted data may include private keys, public keys, digital signatures, etc. The encrypted data is compared against the computerized registry and data is transferred between the computerized registry and the collectible case authentication device. Once authentication is complete, a new set of encrypted data is sent to the collectible case authentication device from the computerized registry. In addition, the computerized registry stores data associated with the collectible case authentication device from the authentication process. Data stored may be authentication number, IP address of a previous authentication, authentication time, authentication location, second digital signature, historical GPS data, and owner information.

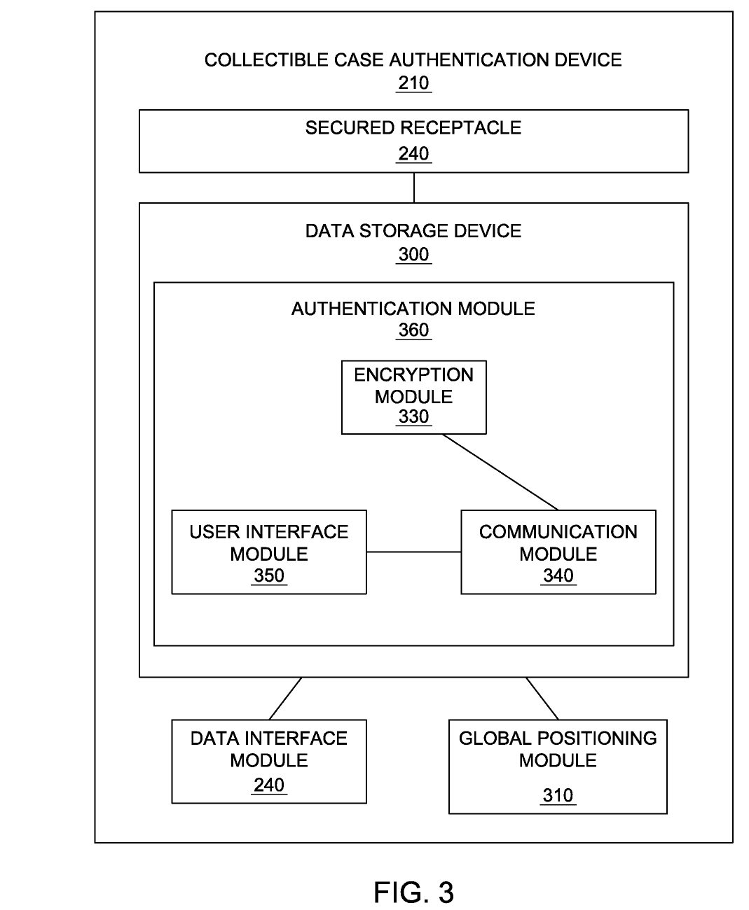

FIG. 3 is a module diagram of a collectible case authentication device 210, according to one embodiment of the invention. The illustrated collectible case authentication device 210 includes a secured receptacle 240 coupled to a data storage device 300 that is also coupled to a data interface module 240 and a global positioning module 310. Accordingly, the collectible case authentication device 210 may secure a collectible associated with tools helpful in authentication of the collectible.

The illustrated data storage device 300 is configured to store information. Non-limiting examples of data storage devices include: hard drives, flash drives, USB thumb-drives, RAM, solid state drives, DVDs and the like. Non-limiting examples include: a HP Storage Works P2000 G3 Modular Smart Array System, manufactured by Hewlett-Packard Company, 3000 Hanover Street, Palo Alto, Calif., 94304, USA; a Sony Pocket Bit USB Flash Drive, manufactured by Sony Corporation of America, 550 Madison Avenue, New York, NY, 10022. The illustrated data storage device includes an authentication module 360 configured to facilitate authentication. The illustrated authentication module 360 includes an encryption module 330 in communication with a communication module 340 that is in turn in communication with an interface module 350. It may be that the illustrated authentication module 360 comprises an executable program disposed on the data storage device 300.

The illustrated encryption module 330 is configured to encrypt and/or decrypt information according to an encryption process and may be matched with an encryption schema of another system, such as but not limited to a computerized registry.

The illustrated communication module 340 is configured to send and/or receive information to/from one or more computerized devices, networks, and/or systems. In one nonlimiting example, a communication module 340 includes protocol information and/or commands configured to transmit data over the internet. The illustrated communication module 340 enables the encryption module 330 and the user interface module 350 to send/receive information remote from/to the device.

The illustrated user interface module 350 is configured to provide a user interface. This may be as simple as a command, index value or pointer directing to a user interface module available elsewhere (such as but not limited to a web (http) address of a web page on a remote server) or as complicated as an executable configured to operate on a computerized device and thereby provide information and/or controls to a user.

The illustrated data interface module 240 is configured to communicate with a computerized device, such as but not limited to a desktop computer, smartphone or the like, such as but not limited to by a USB or micro-USB connection.

In one embodiment, an authentication module 360 includes an encryption module 330 including a public key associated with a private key. The authentication module 360 also includes a communication module 340 in communication with the encryption module 330 and the data interface module 240 and configured to communicate over a computerized network. The authentication module 360 further includes a digital signature derived from the private key and in communication with the communication module 340.

The illustrated collectible case authentication device 210 also includes a global positioning module 310 in communication with the data storage device 300 and configured to locate a global position of the collectible case authentication device. Non-limiting examples of global positioning modules include: a global positioning system described in U.S. Pat. No. 6,002,363, issued to Krasner, which is incorporated for their supported teachings herein; a Garmin e Trex Hiking GPS receiver, manufactured by Garmin International, Inc., 1200 East 151^{st} Street, Olathe, Kanas., 66062, USA. The global positioning module 310 may pass global positioning information to the data storage device 300 and/or to the data interface module 240.

In operation of one embodiment of the device 210 of FIG. 3, a user couples the collectible case authentication device to a network, wherein the device automatically connects to a computerized registry over the network. The device sends and receives encrypted information validating the device and thereby the contents of the case. Feedback is provided over the network regarding the registration of the contents, such as but not limited to providing a web page showing and describing the registered contents. Because the authentication is encrypted, such as by using a public/private key pair, counterfeit devices are likely to fail authentication. Advantageously, counterfeit operations will have much greater difficulty in passing off counterfeit goods, even when in receipt of a sample collectible object and/or device, or having observed an authentication process in detail. Further, authentication itself may generate a record that may be displayed during subsequent authentications such that mass reproduction may be caught early even where such is successful in defeating encryption. Furthermore, the computerized registry sends encrypted information to the device after authentication, to further limit counterfeiting after the device has been authenticated.

In operation of one embodiment of the invention, there is an encrypted file on the encryption module of the authentication module encapsulated along side of the collectable. The owner of the collectible receives the collectible and couples the data interface module of the device to a network. The user then authenticates the collectible, through the network, against a computerized registry including a database and a private encryption key. The database and private key may be reached via a website or a private network.

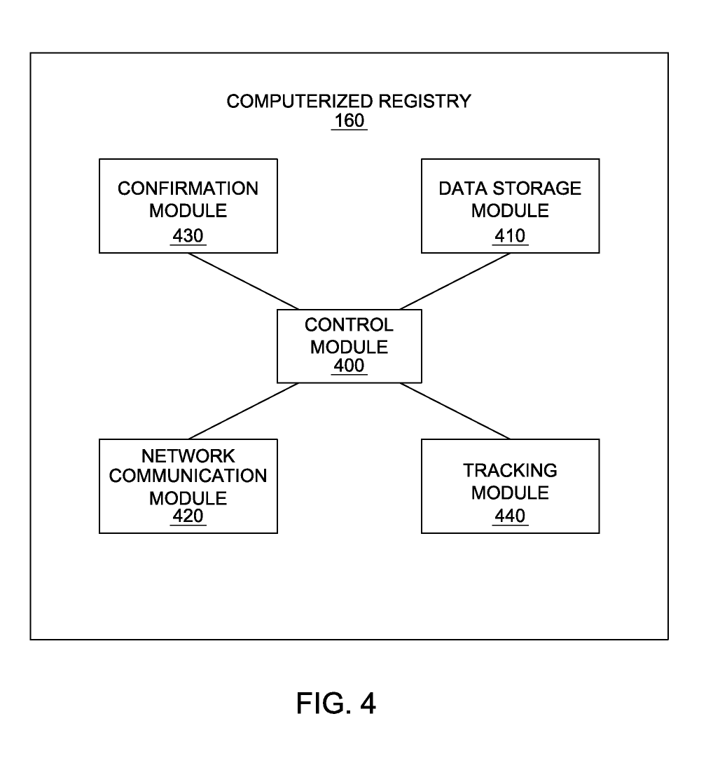

FIG. 4 is a module diagram of a computerized registry 160, according to one embodiment of the invention. The computerized registry 160 includes a control module 400 configured to manage authentication of a collectible case, a data storage module 410 in communication with the control module 400 and configured to store data, a network communication module 420 in communication with the control module 400 and configured to communicate across a network, a confirmation module 430 in communication with the control module 400 and including a private key, and a tracking module 440 in communication with the control module 400 and configured to track authentication history. Accordingly, the computerized registry 160 is able to authenticate and/or track one or more collectible cases that connect thereto.

A data storage module 410 may include a database, a file storage system/protocol, a data indexing system, and/or other systems, programs, devices, and the like configured to store data and/or combinations thereof.

A confirmation module 430 may include one or more systems, programs, and/or devices, configured to compare, contrast, confirm, validate, or otherwise authenticate a communication. There may be an encryption module that may include one or more public/private key pairs and/or associated information. The confirmation module may process received information and compare it to expected information and return a confirmation flag.

A control module 400 may include one or more systems, programs, and/or devices configured to issue commands and/or otherwise manage other systems, programs, and/or devices. A control module may include a scripted set of commands, a command library, communication protocols, process instructions, and the like.

A network communication module 420 may include one or more systems, programs, and/or devices configured to facilitate communication over a network.

A tracking module 440 may include one or more systems, programs, and/or devices configured to facilitate tracking of information, such as but not limited to a database that is fed information based on specific conditions, a query system configured to identify desired information, the like, and/or combinations thereof. A tracking module may issue an alert on fulfillment of a condition set, such as but not limited to a authentication failure. A tracking module may provide supplemental authentication information, such as but not limited to an authentication and/or location history.

In one embodiment, a computerized registry 160 operates and/or includes a server having a processor, a network device, memory storage and an internal communications bus. The illustrated modules may exist as software and/or hardware components on the server and may operate as, on, and/or with one or more of the components of the server. Non-limiting examples of servers include: a HP MediaSmart Server EX495, manufactured by Hewlett-Packard Company, 3000 Hanover Street, Palo Alto, Calif., 94304, USA; a Intel Server System SR2500ALBKPR, manufactured by Intel Corporation, 2200 Mission College Blvd, Santa Clara, Calif., 95054, USA.

In operation of one embodiment of the invention, a user couples the collectible case authentication device to a network. The user then browses through the network to an authentication website. The user then validates the collectible through the website, wherein the website and the device perform an encrypted handshake process that may use one or more public/private key pairings. The collectible is then authenticated and validated of its authenticity and information (date, time, location, etc.) associated with the authentication is tracked for future use.

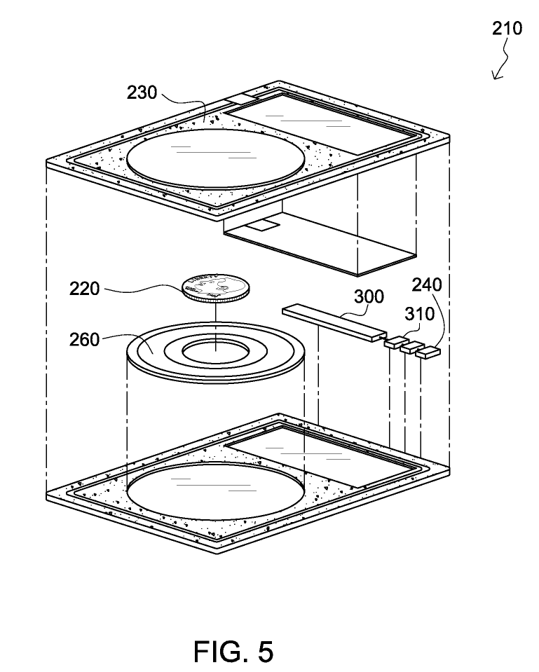

FIG. 5 is an exploded view of a collectible case authentication device 210, according to one embodiment of the invention. The illustrated collectible case authentication device 210 includes a secured housing 230; a data interface module 240 coupled to the secured housing 230 and configured to communicate with a computerized device; a data storage device 300 in communication with the data interface module 240, coupled to the secured housing 230 and configured to store data; a global positioning module 310 in communication with the data storage device 300 and configured to locate a global position of the secured housing 230; and a secured receptacle 260 securely coupled to the data storage device 300 and configured to store a collectible 220. The illustrated secured receptacle 260 is formed by a retaining ring and the transparent faces of the secured housing that entrap the illustrated collectible 220. The illustrated data interface module 240 protrudes/extends/is accessible from outside the secured housing 230 such that an interface cable may be attached thereto for connection to a computerized device.

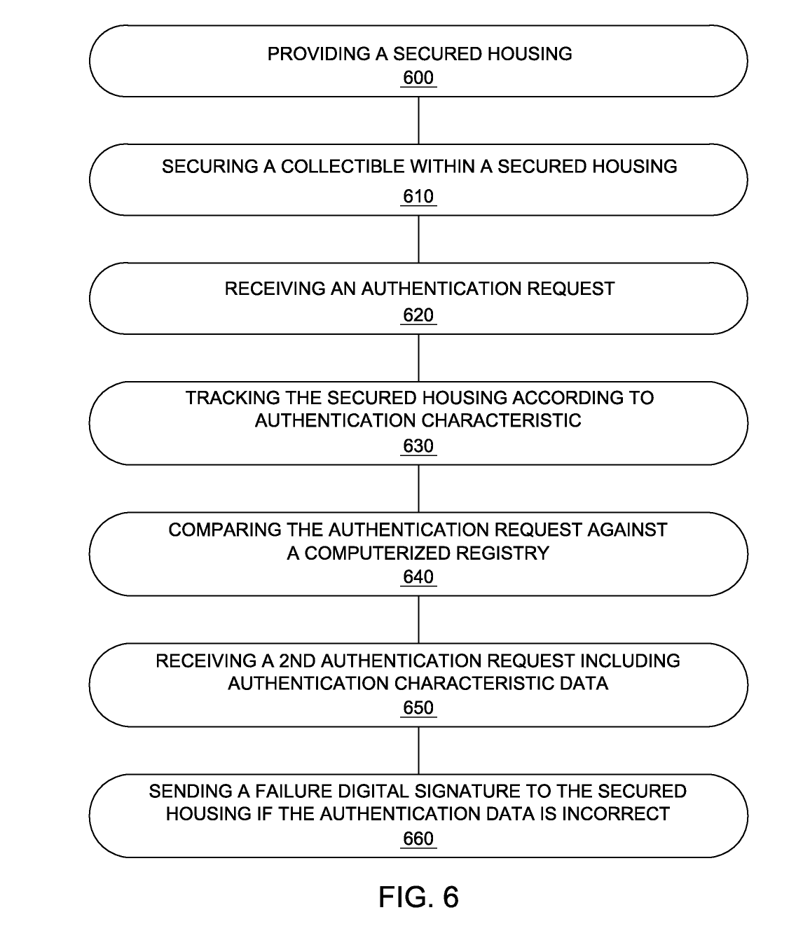

FIG. 6 is a flow diagram of a collectible case authentication method, according to one embodiment of the invention. The illustrated method includes providing a secured housing 600 that may include one or more of the features, structures, functions, modules and/or the like described herein. Then a collectible is secured 610 within the secured housing. This may be accomplished by inserting the collectible, sealing the secured housing about the collectible, and/or the like. The collectible may have been authenticated using a physical-type authentication method prior to, during, or subsequent to securing within the housing as may be appropriate for the technique and other factors.

Then an authentication request is received 620 wherein the request is indexed to the secured housing and/or the collectible protected therein. The authentication request may arrive over a network, such as but not limited to by TCP/IP packet or http request. Then the secured housing is tracked 630 according to an authentication characteristic, such as but not limited to by recording an authentication characteristic in a table of data and/or associating the authentication characteristic with other data. Authentication characteristics include but are not limited to authentication date/time, geolocation of the secured housing, geolocation history of the secured housing, authentication number, ip address of authentication request, handshake information, digital signature, a second digital signature, owner information, and the like.

The authentication request is then compared 640 against a computerized registry. Comparison may include, but is not limited to checking for matching information, matching historical information, expected information, and the like and combinations thereof. Comparison may be, but is not limited to, done by a registry query using the information to be matched and the expected field/record as an argument.

A second authentication request may be received 650 and may include authentication characteristic data. This data may include data previously provided and/or tracked. Accordingly, a failure signal/message/digital signature may be sent 660 to the secured housing if the authentication data is incorrect. This may function to mark/disable/flag or otherwise provide a useful indicator associated with the secured housing.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

The following are non-limiting exemplary descriptions of one or more embodiments of the invention:

Beneficial portions of this embodiment are the ability to provide a single, non-duplicatable, signature assigned specifically to the collectable that is co-encapsulated with the device. This allows validation of the certification at any given time provided the user has access to the encapsulation services web site.

Also, because the device media is not limited to the single file, other files that are not uniquely encrypted can also be placed on the hardware device. These can include images of the collectable certified object. The images may include markers that have been used in the certification process. 3-d imaging, biological markers, chemical markers, or in the case of printed media a comprehensive digital photo gallery can be included. This will allow the ability to view each page of the media once it has been encapsulated and cannot be physically handled any longer.

Furthermore the data on the hardware device may be used to automatically fill important information utilized by other parties such as inventory programs, electronic or online auctions houses such as eBay. This also allows the interested parties the ability to validate the authenticity of the collectable without being in physical possession of the collectable. A non-limiting example of this would be the capability of an auction house to build into their website or internal electronic application a function that would facilitate the RSA encryption validation. A person who has physical possession of the collectable may connect the object to his or her PC. Once this is accomplished, they may begin the process of listing the collectable via an on-line auction site. As part of this process the auction site may elect to transmit the encrypted file to the encapsulation service for validation. This allows the auction house to maintain a level of certainty that the collectable is indeed authentic. Moreover the buyer of the collectable may instantly validate the object via the certification services web site once he or she has received delivery of the collectable. This process will build seller, broker, and buyer confidences due to a new level of assurances provided by the services available when using this device.

Additionally, the encapsulation service may protect their reputation because the unique signature may not be duplicated as is the case with the current technology using serial numbers on a printed media. The encapsulation services have seen a large influx of forgeries not only of the collectable items, but also mimicry of the products they provide such as coin, stamp, comic book, and other encapsulation tamper proof devices.

Collectors may also keep a “virtual” copy collection without having to physically keep the collection with them. This will allow the collectors to compare the items next to other similar items in order to build or improve their collections. The “virtual” collection can also be tied to and assessed with ease via an online system such as **www.greysheet.com** or **www.coinworldtrends.com**. This principal also applies to the insurability of a collection. A “virtual” copy of any collector's collection can be maintained by an insurance company. This will allow insurance companies the ability to ascertain the value of a collection at any given point, thus accelerating claims payouts, and/or allowing them cause to request both increases and decreases of policy because of a change in value of the collection. This too allows the insurance company the ability to validate collectables authenticity so the replacement value can be more accurately tracked allowing policy pay outs to be adjusted for market values as is the case for automobiles and other properties.

Pedigree and providence may also be tracked via the collectable encapsulation companies. Often, collectable item's value increases because of ownership or the item having belonged to a specific collection, holding company or person. The hardware and software involved in this invention make providence and pedigree tracking possible in real time.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention. An example is that, one skilled in the art would appreciate that the housing may be configured to encapsulate a plurality of collectibles and still perform its intended function. Non-limiting examples of a collectible may be: a coin, a currency, a check, a bill, a baseball card, a comic book, or any other certifiable collectible.

It is also envisioned that the components of the device may be constructed of a variety of materials, such as, but not limited to plastic, plastic composite, metal, metal alloys, glass, textiles, rubber, rubber composites, etc. and still perform its intended function.

For example, although the figures illustrate a collectible case authentication device securing a collectible such as a coin; one skilled in the art would appreciate that the collectible may be, but not limited to: a coin, a document, a jewel, a precious stone, a baseball card, a precious metal, a painting, an antique, or any valuable worth counterfeiting, and still perform its intended function.

Additionally, although the figures illustrate a secured receptacle configured to receive a coin; one skilled in the art would appreciate that the secured receptacle may vary in size, shape, design, configuration, length, height, width, etc. and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A collectible case authentication system configured to authenticate a collectible against a computerized registry, comprising:
a) a computerized registry in communication with a network, including:
a) a control module configured to manage authentication of a collectible case;
b) a data storage module in communication with the control module and configured to store data;
c) a network communication module in communication with the control module and configured to communicate across a network;
d) a confirmation module in communication with the control module and including a private key;
e) a tracking module in communication with the control module and configured to track authentication history;
b) a secured housing in communication with the computerized registry over a network, including:
a) a data interface module configured to provide interface controls to the system;
b) a data storage device in communication with the data interface module configured to store data including an authentication module, comprising:
i) an encryption module including a public key associated with the private key;
ii) a communication module in communication with the encryption module and data interface module and configured to communicate;
iii) a digital signature derived from the private key of the confirmation module and in communication with the communication module; and
iv) a user interface module in communication with the communication module and configured to provide an user interface;
c) a global positioning module in communication with the data storage device and configured to locate a global position of the secured housing; and
d) a secured receptacle securely coupled to the data storage device and configured to store a collectible.

2. The system of claim 1, wherein the tracking module tracks each authentication event by an authentication characteristic and wherein the data storage device tracks each authentication by a matching characteristic.

3. The system of claim 1, wherein the authentication history includes an authentication characteristic selected from the group of authentication characteristics consisting of authentication number, IP address of a previous authentication, authentication time, authentication location, second digital signature, historical GPS data, and owner information.

4. The system of claim 1, wherein the confirmation module includes a second private key having no associated public key on data storage device.

5. The system of claim 1, wherein the authentication history includes an authentication characteristic selected from the group of authentication characteristics consisting of authentication number, IP address of a previous authentication, authentication time, authentication location, and historical GPS data.

6. The system of claim 1, wherein the housing further includes an optical marker.

7. The system of claim 1, wherein the user interface displays an advertisement during authentication.

8. The system of claim 1, wherein the computerized registry includes an advertising module configured to push advertising media to be displayed on the user interface module.

9. A collectible case authentication device configured to facilitate authentication of a collectible, comprising:
a) a secured housing;
b) a data interface module coupled to the secured housing and configured to communicate with a computerized device;
c) a data storage device in communication with the data interface module, coupled to the secured housing and configured to store data including an authentication module, the authentication module comprising:
i) an encryption module including a public key associated with a private key;
ii) a communication module in communication with the encryption module and data interface module and configured to communicate over a computerized network;
iii) a digital signature derived from the private key and in communication with the communication module; and
iv) a user interface module in communication with the communication module and configured to provide a user interface;
d) a global positioning module in communication with the data storage device and configured to locate a global position of the secured housing; and
e) a secured receptacle securely coupled to the data storage device and configured to store a collectible.

10. The device of claim 9, wherein the user interface displays an advertisement during authentication.

11. The device of claim 10, wherein the housing further includes an optical marker.

12. The device of claim 11, wherein the authentication history includes an authentication characteristic selected from the group of authentication characteristics consisting of authentication number, IP address of a previous authentication, authentication time, authentication location, second digital signature, historical GPS data, and owner information.

13. The device of claim 12, wherein the confirmation module includes a second private key having no associated public key on data storage device.

14. The device of claim 13, wherein the authentication history includes an authentication characteristic selected from the group of authentication characteristics consisting of authentication number, IP address of a previous authentication, authentication time, authentication location, and historical GPS data.

15. A method of authenticating a collectible, comprising the steps of:
a) providing a secured housing including
a1) a data interface module configured to provide interface controls to the housing;
a2) a data storage device in communication with the data interface module configured to store data including an authentication module, comprising:
i) a communication module in communication with the data interface module and configured to communicate;
ii) a digital signature derived from a private key and in communication with the communication module; and
iii) a user interface module in communication with the communication module and configured to provide an user interface;
a3) a global positioning module in communication with the data storage device and configured to locate a global position of the secured housing; and
a4) a secured receptacle securely coupled to the data storage device and configured to store a collectible;
b) securing the collectible within the secured receptacle;
c) receiving an authentication request from the authentication module over a computerized network; and
d) comparing the authentication request against a computerized registry including a record associated with the secured housing.

16. The method of claim 15, further comprising the step of tracking authentication events according to an authentication characteristic.

17. The method of claim 16, further comprising the step of receiving a second authentication request including information associated with the tracked authentication characteristic and comparing the second authentication request against the tracked authentication characteristic.

18. The method of claim 15, further comprising the step of pushing a media presentation to the interface module.

19. The method of claim 15, further comprising the step of, if authentication fails, pushing a second digital signature to the data storage device, wherein the second digital signature is associated with an authentication failure record.

20. The method of claim 15, further comprising the step of tracking authentication history according to an authentication characteristic including a characteristic selected from the group of authentication characteristics consisting of authentication number, IP address of a previous authentication, authentication time, authentication location, second digital signature, historical GPS data, and owner information.
